(19) United States
(12) Patent Application Publication
(10) Pub. No.: US 2018/0142100 A1
(43) Pub. Date: May 24, 2018

(54) PRECISION CASTING WAX BASED ON GRAPHITE OXIDE MODIFIED ROSIN AND PRODUCTION METHOD THEREOF

(71) Applicant: Dongguan University of Technology, Dongguan (CN)

(72) Inventors: Yongjun Xu, Dongguan (CN); Zhuodi Cai, Dongguan (CN); Qiwen Cai, Dongguan (CN); Huibin Yin, Dongguan (CN)

(21) Appl. No.: 15/648,136

(22) Filed: Jul. 12, 2017

(30) Foreign Application Priority Data
Jun. 2, 2016 (CN) 201610384105.0

(51) Int. Cl. C08L 93/04; B29C 39/00; B29C 39/38

(52) U.S. Cl. CPC C08L 93/04; B29K 2091/00; B29C 39/38; B29C 39/003

(57) ABSTRACT

Disclosed are a precision casting wax based on graphite oxide modified rosin and its production method. The precision casting wax is composed of 20%˜30% of modified rosin, 50%˜65% of paraffin, 5%˜10% of an adhesion agent, 5%˜40% of PE wax, and 0%˜3% of montan wax (in mass percentage), and the total content adds up to 100%. The modified rosin is composed of first-grade rosin, graphite oxide, zinc oxide and pentaerythritol. The graphite oxide, zinc oxide, and pentaerythritol have a mass equal to 5%˜8%, 0.3%˜0.5%, and 5%˜8% of the mass of the first-grade rosin respectively. The modified rosin has a softening point of 98° C.˜103° C. and an acidity value of 15 KOH/g˜25 KOH/g. The present invention has the features of small needle penetration, small linear shrinkage rate, large bending strength, and small ash content, and thus can satisfy the requirements of high size precision and high surface quality of the precision casting.

### Field of Invention

The present invention relates to the field of casting wax, and more specifically relates to a precision casting wax based on graphite oxide modified rosin and its production method.

### BACKGROUND OF INVENTION

Precision (welding) casting is a casting technique with little or no cutting developed from that developed from ancient lost wax casting methods, which is an excellent process technology in the casting industry and almost applied in all industrial units and organizations, particularly for the industries including electronics, petroleum, chemical engineering, nuclear energy, transportation, light industry, pharmaceutical, medical instrument, pump, valve, etc.

Precision casting wax is an important material for welding casting, and the precision casting wax generally has three main requirements, respectively: thermal physical property, mechanical property, and processing property, wherein the requirements for the thermal physical property include appropriate melting temperature range and solidification temperature range, the smallest possible thermal expansion rate and shrinkage rate, and stable chemical properties of the wax at a high temperature; the requirements of the mechanical property include appropriate strength, hardness, plasticity and toughness; and the requirements of the processing property include appropriate viscosity in liquid state, appropriate mobility for mold making, and the smallest possible ash content.

China has a plentiful resource of rosin, and rosin is one of the important products of the forest/chemical industry of China. Rosin is a major industry and also an important material for manufacturing precision casting wax. However, rosin is brittle, easily oxidized, highly acidic, and easily deteriorated to produce carcinogenic substances when used in a casting wax, not conducive to occupational health, increasing the viscosity of mold materials and the shrinkage rate, and lowering the process performance. Therefore, rosin must be modified or other substances are added to the rosin to overcome the aforementioned problems for its use. The principle of the esterification of rosin is similar to that of fatty acids, but the carboxyl group of the rosin is situated on the tertiary carbon atom, so that the steric hindrance is large, and its reaction requires high activation energy, a temperature greater than the temperature of the esterification reaction of a general fatty acid (250˜300° C.), a longer reaction time (6˜11 h), and a highly active catalyst.

### SUMMARY OF THE INVENTION

To overcome the aforementioned problems, the present invention provides a precision casting wax based on graphite oxide modified rosin and its production method capable of satisfying the requirements of small needle penetration, small linear shrinkage rate, large bending strength, small ash content, high size precision, and high surface quality of the precision casting.

The precision casting wax based on graphite oxide modified rosin in accordance with the present invention comprises the following components in percentage by mass: 20%˜30% of modified rosin. 50%˜65% of paraffin, 5%˜10% of an adhesion agent, 5%˜10% of PE wax, and 0%˜3% of montan wax, wherein the total content of the components is 100%.

In some embodiments, the components of the modified rosin are first-grade rosin, graphite oxide, zinc oxide and pentaerythritol; the mass of the graphite oxide is equal to 5%˜8% of the mass of the first-grade rosin; the mass of the zinc oxide is equal to 0.3%˜0.5% of the mass of the first-grade rosin; the mass of the pentaerythritol is equal to 5%˜8% of the mass of the first-grade rosin; and the modified rosin has a softening point of 98° C.˜103° C. and an acidity value of 15 KOH/g˜25 KOH/g.

In some embodiments, the paraffin is one or more selected from the group consisting of 58#, 62#, 64#, 66#, 68#, and 70# fully-refined or semi-refined waxes.

In some embodiments, the adhesion agent is one or more selected from the group consisting of terpene resin, C5 petroleum resin, hydrogenated C5 petroleum resin and hydrogenated rosin.

In some embodiments, the PE wax has a melting point of 100˜120° C.

In some embodiments, the montan wax has a melting point of 75° C.˜90° C.

The production method of a precision casting wax based on graphite oxide modified rosin in accordance with the present invention comprises the steps of:

1) preparing a modified rosin;

2) obtaining 20%˜30% of the modified rosin, adding 5%˜10% of an adhesion agent, 5%˜10% of PE wax, and 0%^{,}˜3% of montan wax into the modified rosin, heating and blending the mixture until the mixture is melted completely to obtain a mixed solution A;

3) adding 50%˜65% of paraffin into the mixed solution A after melting, and heating and blending the mixed solution A until the mixed solution A is melted completely to obtain a mixed solution B;

4) cooling the mixed solution B after melting to produce particles to obtain the precision casting wax based on graphite oxide modified rosin.

In some embodiments, preparing the modified rosin of Step 1) can be as follows, the first-grade rosin is obtained, and dissolved at 120° C. to form a first-grade rosin solution, and then graphite oxide with a mass equal to 5%˜8% of the mass of the first-grade rosin, zinc oxide with a mass equal to 0.3%˜0.5% of the mass of the first-grade rosin, and pentaerythritol with a mass equal to 5%˜8% of the mass of the first-grade rosin are added sequentially into the first-grade rosin solution to obtain a mixed solution, and the mixed solution is heated to 250° C.˜290° C., and blended until the mixed solution is in a molten state, so as to obtain a modified resin with a softening point of 98° C.˜103° C., and an acidity value of 15 KOH/g˜25 KOH/g.

In some embodiments, the system temperature of Step 2) is 120° C.˜160° C.

In some embodiments, the system temperature of Step 3) is 90° C.˜11.0° C.

The present invention has the following advantages and effects:

1. First, the precision casting wax of the present invention has a paraffin content of 50%˜65%, and a modified rosin content of 20%˜30%. Compared with the conventional precision casting wax, the present invention has high paraffin content and low modified rosin content. Since paraffin is low priced, therefore the production cost can be reduced significantly.

Second, the present invention modifies the rosin by adding pentaerythritol into first-grade rosin. The rosin is reacted with pentaerythritol under the catalysis of graphite oxide and co-catalyst zinc oxide. Rosin contains conjugated double bonds and has high chemical reactivity, and can react with pentaerythritol in the presence of the catalyst above to undergo an esterification reaction and produce rosin pentaerythritol ester. Compared with the unmodified rosin, the modified rosin pentaerythritol ester has the features of higher strength, difficult-to-be-oxidized, appropriate acidity, not producing carcinogenic substances during the use of the casting wax, and having a good compatibility with paraffin, and modified rosin has a good adhesion with adhesive resins. The precision casting wax formed from melting modified rosin of the present invention, paraffin, PE wax, an adhesion agent, and montan wax is characterized by a small needle penetration, small linear shrinkage rate, large bending strength, and small ash content, and the precision casting wax can satisfy very well the requirements of high precision and surface quality of the precision casting.

Third, the catalytic graphite oxide used in the production process of the modified rosin can improve the efficiency of the synthesis of the modified rosin. In addition, it is not necessary to separate the graphite oxide while making the modified rosin, but the mixture containing the esterified pentaerythritol, the graphite oxide, the zinc oxide and the pentaerythritol may be directly used for producing the precision casting wax. Therefore, the production process is simple, and the graphite oxide can act as a filler to improve the strength and gloss of the precision casting wax, and the pentaerythritol can act as a reactant of the precision casting wax to further improve various performances of the precision casting wax,

2. The chemical formula and design of the present invention are reasonable, and tests show that different parameters of the precision casting wax adopting such formula and design are better.

3. To meet different using requirements, the quantity of pentaerythritol added into the rosin may change the softening point of the finally produced precision casting wax, so as to broaden the scope of applicability.

4. In the production method of the precision casting wax of the present invention, after pentaerythritol is used to modify the rosin, the pentaerythritol ester with small steric hindrance, low temperature of rosin esterification reaction, and short reaction time, and no longer needs a highly active catalyst for the reaction. The whole production method is simple, and the production process of the modified rosin does not need to separate the pentaerythritol and catalyst which are used as the reactants for the synthesis of the precision casting wax. Therefore, the production method is simple, and the produced precision casting wax has good performance.

### DESCRIPTION OF SPECIFIC EMBODIMENTS

The present invention is further elaborated by specific embodiments as follows:

### Embodiment 1

100 g of first-grade rosin (Jiangxi Masson Pine, softening point 82° C.) was added into a 1-liter high pressure reaction kettle and dissolved at 120° C., and 5 g of catalytic graphite oxide (equal to 5% of the mass of rosin) (Hubei Yihua Chemical Industry Co., Ltd.), 3 g of co-catalytic zinc oxide (equal to 0.3% of the mass of rosin) (Nanhua brand), and 5 g of pentaerythritol (equal to 5% of the mass of rosin) (Hubei Yihua Chemical Industry Co., Ltd.) were added, blended, and melted. The kettle was sealed and heated up to 280° C., and the system temperature was controlled to be not over 290° C., and the aforementioned chemical substances reacted for 3 hours. It was not necessary to separate the co-catalytic zinc oxide and catalytic graphite oxide from the remained pentaerythritol in the system to obtain a modified rosin resin mixture. The air in the kettle was s discharged and the pressure was released to drop the system temperature to approximately 140° C., and 40 g (8%) of C5 petroleum resin (YH-1288, Henghe Materials & Science Technology Co., Ltd.), 25 g (5%) of PE wax (SCG Chemicals, Thailand/LP0500F polyethylene wax, 115° C.) and 10 g (2%) of montan wax (Shangcheng brand, Yunnan) were added and completely melted, and then the mixture was further stirred for 30 minutes to drop the system temperature to approximately 100° C. 312 g (62.4%) of 58# semi-refined paraffin (Maoming Petrochemical, Nanhai brand) was added, heated, blended and melted, and then the mixture was further blended for 30 minutes, and finally cooled to form particles, so as to obtain the precision casting wax of the present invention.

Control Group 1: 113 g of unmodified rosin (with other conditions same as those of Embodiment 1) was added into a 1-liter high pressure reaction kettle and melted at 140° C., and 40 g (8%) of C5 petroleum resin, 25 g (5%) of PE wax, and 10 g (2%) of montan wax were added and completely melted, and further stirred for 30 minutes to drop the system temperature to approximately 100° C., and 312 g (62.4%) of paraffin was added, heated, blended and melted, and the mixture was further stirred for 30 minutes and cooled to form particles, so as to obtain the precision casting wax.

### Embodiment 2

100 g of first-grade rosin (Jiangxi Masson Pine, softening point 82° C.) was added into a 1-liter high pressure reaction kettle and dissolved at 120° C., and 8 g of catalytic graphite oxide (equal to 5% of the mass of rosin) (Hubei Yihua Chemical Industry Co., Ltd.), 3 g of co-catalytic zinc oxide (equal to 0.3% of the mass of rosin) (Nanhua brand), 5 g of pentaerythritol (equal to 5% of the mass of rosin) (Hubei Yihua Chemical Industry Co., Ltd.) were added, blended, and melted. The kettle was sealed and heated up to 280° C., and the system temperature was controlled to a temperature not over 290° C., and the aforementioned chemical substances were reacted for 3 hours, and it was not necessary to separate the co-catalytic zinc oxide and the catalytic graphite oxide from the remained pentaerythritol in the system to obtain a modified rosin resin mixture, and then the air in the kettle was discharged and released to drop the system temperature to approximately 140° C., and 40 g (8%) of terpene resin (T100, Shenzhen Jitian Chemical Co., Ltd.), 25 g (5%) of PE wax (SCG Chemicals, Thailand/LP0500F polyethylene wax, 115° C.) and 10 g (2%) of montan wax (Shangcheng brand, Yunnan) were added and melted completely, and then the mixture was further stirred for 30 minutes to drop the system temperature to approximately 100° C., and 309 g (62.4%) of 62# fully refined paraffin (Maorning Petroleum. Co., Ltd., Nanhai brand) was added, heated, blended and melted, and then further blended for 30 minutes, and finally cooled to form particles, so as to obtain the precision casting wax.

Control Group 2: 116 g of unmodified rosin (with other conditions same as those of Embodiment 2) was added into a 1-liter high pressure reaction kettle and melted at 140° C., and 40 g (8%) of C5 petroleum resin, 25 g (5%) of PE wax, and 10 g (2%) of montan wax were added and completely melted, and further stirred for 30 minutes to drop the system temperature to approximately 100° C., and 312 g (62.4%) of paraffin was added, heated, blended and melted, and the mixture was further stirred for 30 minutes and cooled to form particles, so as to obtain the precision casting wax.

### Embodiment 3

125 g of first-grade rosin (Jiangxi Masson Pine, softening point 82° C.) was added into a 1-liter high pressure reaction kettle and dissolved at 120° C., and 6.25 g of catalytic graphite oxide (equal to 5% of the mass of rosin) (Hubei Yihua Chemical. Industry Co., Ltd.), 3.75 g of co-catalytic zinc oxide (equal to 0.3% of the mass of rosin) (Nanhua brand), and 6.25 g of pentaerythritol (equal to 5% of the mass of rosin) (Hubei Yihua Chemical Industry Co., Ltd.) were added, blended, and melted. The kettle was sealed and heated up to 280° C., and the system temperature was controlled to a temperature not over 290° C., and the aforementioned chemical substances were reacted for 3 hours, and it was not necessary to separate the catalytic zinc oxide and graphite oxide from the remained pentaerythritol in the system to obtain a modified rosin resin mixture, and then the air in the kettle was discharged and released to drop the system temperature to approximately 140° C., 40 g (8%) of terpene resin (T100, Shenzhen Jitian Chemical Co., Ltd.), 25 g (7%) of PE wax (SCG Chemicals, Thailand/LP0500F polyethylene wax, 115° C.) and 10 g (2%) of montan wax (Shangcheng brand, Yunnan) were added and melted completely, and then the mixture was further stirred for 30 minutes to drop the system temperature to approximately 100° C. 283.75 g (62.4%) of 62# fully refined paraffin (Maoming Petroleum Co., Ltd., Nanhai brand) was heated, blended and melted, and the mixture was further blended for 30 minutes and cooled to form particles, so as to obtain the precision casting wax.

Control Group 3: 141.25 g of unmodified rosin (with other conditions same as those of Embodiment 3) was added into a 1liter high pressure reaction kettle and melted at 140° C., and 40 g (8%) of CS petroleum resin, 25 g (5%) of PE wax, and 10 g (2%) of montan wax were added and completely melted, and the mixture was further stirred for 30 minutes to drop the system temperature to approximately 100° C., and 283.75 g (62,4%) of paraffin was added, heated, blended and melted, and the mixture was further stirred for 30 minutes and cooled to form particles, so as to obtain the precision casting wax.

Performance Tests: The samples of precision casting wax of Embodiment 1, Embodiment 2, Embodiment 3, Control Group 1, Control Group 2 and Control Group 3 were measured and tested in the related material laboratory of Dongguan University of Technology, and the softening point, needle penetration, linear shrinkage rate, bending strength, viscosity and acidity value of each precision casting wax were measured and tested, and the experiment results are listed in Table 1 as follows:

Softening point: GB/T4507-84

Needle penetration: GB/T14235.5-93

Linear shrinkage rate: GB/T14235.4-93

Bending strength: GB/T14235.2-93

Ash content: GB/T14235.3-93

Viscosity: GB/T 14235.8-1993

Acidity value: GB/T 14235.6-1993

TABLE 1
Statistic Table of Experiment Results

| | Softening | | | | | | |
|---|---|---|---|---|---|---|---|
| | Point | | | | | | |
| | (Ring | Needle | | | | | Acidity |
| | and Ball | Penetration | Linear | Bending | Ash | | Value |
| | Method | (25° C. | Shrinkage | Strength | Content | Viscosity | (mg |
| Item | ° C.) | 0.1 mm) | Rate (%) | (MPa) | (%) | (mm2/120° C.) | KOH/g) |
| Embodiment | 73.2 | 5.2 | 0.52 | 14 | <0.02 | 67 | 6 |
| 1 | | | | | | | |
| Control | 70.1 | 7.0 | 0.73 | 11 | <0.02 | 82 | 16 |
| Group 1 | | | | | | | |
| Embodiment | 75.8 | 4.5 | 0.53 | 16 | <0.02 | 69 | 6 |
| 2 | | | | | | | |
| Control | 72.6 | 6.3 | 0.78 | 12 | <0.02 | 81 | 17 |
| Group 2 | | | | | | | |
| Embodiment | 76.7 | 4.2 | 0.43 | 17 | <0.02 | 76 | 6.8 |
| 3 | | | | | | | |
| Control | 73.1 | 6.1 | 0.81 | 12 | <0.02 | 93 | 18.4 |
| Group 3 | | | | | | | |

### Analysis of the Results:

From the statistics table of experiment results (Table 1), after the rosin was modified, various different parameters of the precision casting wax were affected significantly, and the softening point of the precision casting wax of the present invention can be adjusted according to the selected materials to meet the requirements of smaller needle penetration, smaller linear shrinkage rate, larger bending strength, and smaller ash content and the invention further satisfied the requirements of high size precision and high surface quality of the precision casting. In summation, the precision casting wax of the present invention had good data and met the requirements of its practical production.

The embodiments described above are merely illustrative of several embodiments of the invention and are more specific and detailed. These are not to be construed as limiting the scope of the invention. While the invention has been described by means of specific embodiments, numerous modifications and variations could be made thereto by those Skilled in the art without departing from the scope and spirit of the invention set forth in the claims.

What is claimed is:

1. A precision casting wax based on graphite oxide modified rosin, comprising the following components in percentage by mass:
20%˜30% of modified rosin, 50%˜65% of paraffin, 5%˜10% of an adhesion agent, 5%˜10% of PE wax, and 0%˜3% of montan wax, wherein the total content of the components is 100%.

2. The precision casting wax based on graphite oxide modified rosin according to claim 1, wherein the components of the modified rosin are first-grade rosin, graphite oxide, zinc oxide and pentaerythritol; the mass of the graphite oxide is equal to 5%˜8% of the mass of the first-grade rosin; the mass of the zinc oxide is equal to 0.3%˜0.5% of the mass of the first-grade rosin; the mass of the pentaerythritol is equal to 5%˜8% of the mass of the first-grade rosin; and the modified rosin has a softening point of 98° C.˜103° C. and an acidity value of 15 KOH/g˜25 KOH/g.

3. The precision casting wax based on graphite oxide modified rosin according to claim 1, wherein the paraffin is one or more selected from the group consisting of 58#, 62#, 64#, 66#, 68#, and 70# fully-refined or semi-refined waxes.

4. The precision casting wax based on graphite oxide modified rosin according to claim 1, wherein the adhesion agent is one or more selected from the group consisting of terpene resin, C5 petroleum resin, hydrogenated C5 petroleum resin and hydrogenated rosin.

5. The precision casting wax based on graphite oxide modified rosin according to claim 1, wherein the PE wax has a melting point of 100˜120 ° C.

6. The precision casting wax based on graphite oxide modified rosin according to claim 1, wherein the montan wax has a melting point of 75° C.˜90° C.

7. A production method of a precision casting wax based on graphite oxide modified rosin, comprising:
1) preparing a modified rosin;
2) obtaining 20%˜30% of the modified rosin, adding 5%˜10% of an adhesion agent, 5%˜1.0% of PE wax, and 0%˜3% of montan wax into the modified rosin, heating and blending the mixture until the mixture is melted completely to obtain a mixed solution A;
3) adding 50%˜65% of paraffin into the melted mixed solution A, and heating and blending the resulted mixture until it is melted completely to obtain a mixed solution B;
4) cooling the melted mixed solution B to produce particles to obtain the precision casting wax based on graphite oxide modified rosin.

8. The production method of the precision casting wax based on graphite oxide modified rosin according to claim 7, wherein preparing the modified rosin of Step 1)_{—} comprises: providing a first-grade rosin, dissolving the first-grade rosin at 120° C. to obtain a first-grade rosin solution, and then adding graphite oxide, in an amount of 5%˜8% by weight of the first-grade rosin, zinc oxide, in an amount of 0.3%˜0.5% by weight of the first-grade rosin, and pentaerythritol, in an amount of 5%˜8% by weight of the first-grade rosin, sequentially into the first-grade rosin solution to obtain a mixed solution, and heating the mixed solution to 250° C.˜290° C., and blending the mixed solution until the mixed solution is in a molten state, so as to obtain a modified resin with a softening point of 98° C.˜103° C., and an acidity value of 15 KOH/g˜25 KOH/g.

9. The production method of the precision casting wax based on graphite oxide modified rosin according to claim 7, wherein the system temperature of Step 2) is 120° C.˜160° C.

10. The production method of the precision casting wax based on graphite oxide modified rosin according to claim 7, wherein the system temperature of Step 3) is 90° C.˜110° C.
